(19) United States
(12) Patent Application Publication
(10) Pub. No.: US 2005/0193701 A1
(43) Pub. Date: Sep. 8, 2005

(54) Apparatus for processing of organic material

(75) Inventors: Jason Mathew Banowetz, Glenside, PA (US); Jon Robert Eberle, Doylestown, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Schiller-Pfeiffer, Inc.

(21) Appl. No.: 10/781,097

(22) Filed: Feb. 18, 2004

(51) Int. Cl. A01D 46/00

(52) U.S. Cl. 56/13.3

(57) ABSTRACT

The invention is an apparatus for processing lawn and garden organic debris. The apparatus includes a fan housing, a retainer plate coupled to and forming a slot with the fan housing and a hose having a flange. The flange is releaseably positionable within the slot to connect the hose with the fan housing. The apparatus further includes a nozzle having a non-planar inlet face.

### BACKGROUND OF THE INVENTION

The present invention relates to a machine for processing lawn and garden organic debris material to reduce the size of, or to shred, the debris. More particularly, the invention relates to a machine capable of generating suction to ingest organic debris in its natural state, processing the debris into smaller pieces, and expelling the reduced debris material. Such apparatuses are known in the prior art, and typically comprise an inlet duct having an inlet nozzle; a fan having a plurality of fan blades; a housing enclosing the fan, the inlet duct being either fixedly or removably connected to the fan housing; and an outlet duct through which the material is discharged. The prior art discloses the inlet duct to fan housing connection being accomplished using various techniques, including use of a plurality of conventional threaded connectors. This conventional connection technique, while effective, requires substantial time and effort to properly connect the inlet duct to and disconnect the inlet duct from the fan housing. Furthermore, the prior art discloses an inlet face of the inlet nozzle being generally planar. With such a planar configuration, the inlet nozzle is prone to attach itself by suction to planar surfaces during operation. Still further, the prior art discloses generally flat fan blades, and the shredding process being accomplished solely by the fan blades. It is believed that an apparatus providing novel features relating to the manner in which the inlet duct is coupled to the fan housing, configuration of the fan blades, operation of the shredding process and configuration of the nozzle inlet, with each of the novel features providing improved performance of the apparatus, would be desirable.

### BRIEF SUMMARY OF THE INVENTION

Briefly stated, in a presently preferred embodiment the invention is an apparatus for processing lawn and garden organic debris. The apparatus comprises a fan housing having a wall with an opening for allowing air to pass therethrough. A retainer plate surrounds a portion of the opening and is coupled to the wall. The retainer plate is spaced from the wall to define a slot between the wall and the retainer plate. The apparatus further comprises a hose having a nozzle at a first end and a flange at a second end. The flange is releasably positionable in the slot such that the opening and hose are in fluid communication.

### BRIEF DESCRIPTION OF THE SEVERAL VIEWS OF THE DRAWINGS

The following detailed description of a preferred embodiment of the invention will be better understood when read in conjunction with the appended drawings. For the purpose of illustrating the invention, there are shown in the drawings an embodiment which is presently preferred. It should be understood, however, that the invention is not limited to the precise arrangements and instrumentalities shown.

In the drawings:

FIG. 1 is a side perspective view of an apparatus for processing lawn and garden organic material in accordance with a preferred embodiment of the present invention;

FIG. 2 is an enlarged exploded perspective view of a fan housing assembly of the apparatus of FIG. 1;

FIG. 3 is an exploded perspective view of an inlet hose assembly of the apparatus of FIG. 1;

FIG. 3A is side elevation view of an inlet nozzle of the apparatus of FIG. 1

FIG. 4A is a side perspective view of an inlet flange assembly of the apparatus of FIG. 1;

FIG. 4B is a side perspective view of the inlet flange assembly of FIG. 4A, shown with a portion of the inlet hose assembly coupled thereto;

FIG. 5 is an enlarged front elevational view of a fan assembly of the apparatus of FIG. 1; and

FIG. 6 is an enlarged front perspective view of a blade ring of the apparatus of FIG. 1.

### DETAILED DESCRIPTION OF THE INVENTION

Certain terminology is used in the following description for convenience only and is not limiting. The words “right”, “left”, “top”, and “bottom” designate directions in the drawings to which reference is made. The words “interior” and “exterior” refer to directions towards and away from, respectively, the geometric center of the apparatus or designated parts thereof. The terminology includes the words above specifically mentioned, derivatives thereof and words of similar meaning.

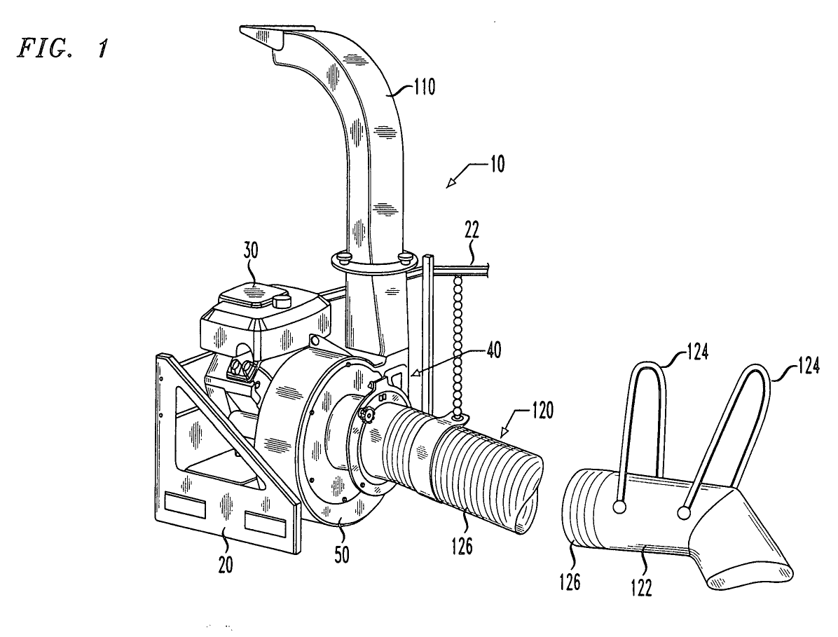

Referring to the drawings, wherein like referenced numerals are used to designate the same components throughout the figures, there is shown in FIGS. 1-6 an apparatus, generally designated 10, for processing lawn and garden organic debris in accordance with a presently preferred embodiment of the present invention. With particular reference to FIG. 1, the apparatus 10 comprises a frame 20, a motor 30 supported by the frame 20, a housing assembly 40 also supported by the frame 20, a discharge chute 110 coupled to the housing assembly 40 and a hose assembly 120 also coupled to the housing assembly 40. The hose assembly 120 includes a hose 126 and a inlet nozzle 122 having handles 124. Preferably, a support arm 22 extends from the frame 20 to support the hose 126. The frame 20 is preferably fabricated from a high strength, light weight material, such as steel. The motor 30 is preferably a four cycle gasoline powered engine, such as the VANGUARD™ V-Twin, 16 horsepower engine available from Briggs & Stratton Corporation, located in Wauwatosa, Wis.

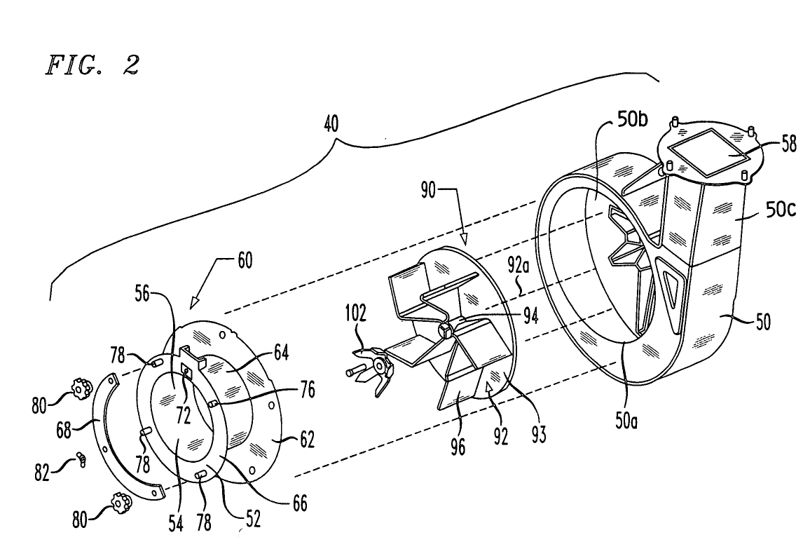

With particular reference now to FIG. 2, the housing assembly 40 includes a fan housing 50 which encloses and supports for rotation a fan assembly 90. The fan housing 50 has a large side opening 50a. A rear wall 50b is located opposite the side opening 50a. A discharge passage 50c is located along an outer periphery of the fan housing 50. The discharge passage 50c terminates in a discharge opening 58. The fan assembly 90 is received within the side opening 50a. The fan assembly 90 rotates about an axis of rotation 92a.

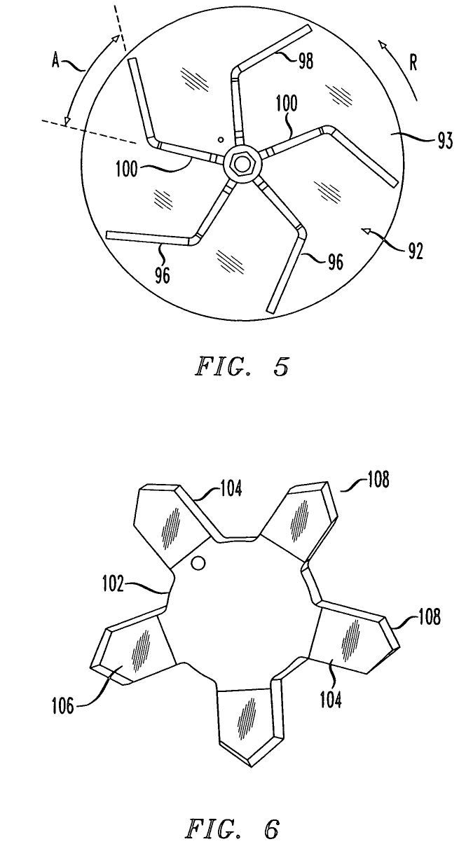

With reference now to FIGS. 2 and 5, the fan assembly 90 includes a preferably circular fan impeller 92 having a generally planar disk 93 from which a plurality of fan blades 96 extend. The fan blades 96 each include a base portion 100 and a tip portion 98. The base portions extend generally radially from the axis of rotation 92a, with each tip portion 98 being inclined relative to its mating base portion 100 in a direction opposite the direction of rotation, labeled “R” in FIG. 5, of the fan impeller. Preferably, the angle of inclination, labeled “A” in FIG. 5, is between 50 and 80 degrees. The base portions 100 have first ends which join together at a central hub 94. The segmented, rearwardly inclined configuration of the blades 96 is believed to provide increased airflow through the apparatus 10 than would be achievable with a fan impeller of similar diameter, rotating at a similar speed and having conventional flat, radially-extending fan blades.

With reference now to FIGS. 2 and 6, the fan assembly 90 further preferably includes a blade ring 102 which is removably connected to the central hub 94. The blade ring 102 comprises a plurality of shredding blades 104 arranged symmetrically and such that the shredding blades 104 extend forwardly from the central hub 94 when the blade ring 102 is attached to the central hub 94. The shredding blades 104 each include a tip 106, having two intersecting, angled, opposing tip edges 108. The tip edges 108 may be sharpened, or may be blunt. As discussed below herein, the blade ring 102 operates to increase the degree of size reduction accomplished by the apparatus 10.

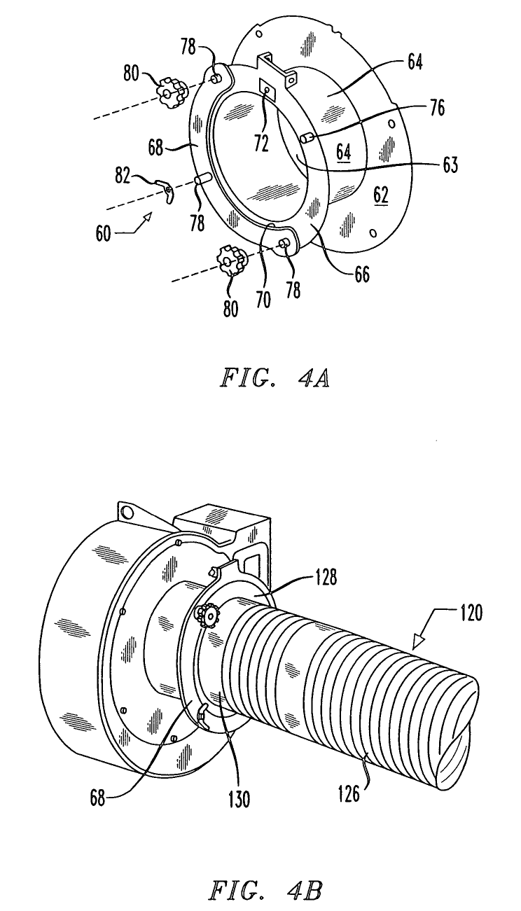

With reference now to FIGS. 2 and 4A, an inlet flange assembly 60 is releasably attachable to the fan housing 50. The inlet flange assembly 60 includes a front plate 62, which is sized and shaped to cover the fan housing side opening 50a. The front plate 62 has a central opening 63 which serves as an inlet 56 to the apparatus 10. A preferably circular cylindrical inlet tube 64 extends from the front plate 62. The inlet tube 64 has a first end fixedly connected to the front plate 62 and a second end to which an inlet flange 66 is fixedly attached. A face of the inlet flange 66 may be considered to be a side wall 52 of the fan housing 50 having an opening 54. The inlet flange assembly 60 is preferably assembled using conventional welding techniques.

With continued reference to FIG. 2 and FIG. 4A, a retainer plate 68 is releasably attachable to the inlet flange 66. The retainer plate 68 surrounds a portion of the opening 63 and is coupled to the wall 52. The retainer plate 68 is spaced from the wall 52 to define a slot 70 between the wall 52 and the retainer plate 68. The retainer plate 68 preferably has a semi-circular shape complementing the preferably circular shape of the opening 63. In the embodiment illustrated, the retainer plate 68 is provided with through holes which are positioned to allow the retainer plate 68 to be slidingly received over at least two, and preferably three threaded studs 78 extending from the inlet flange 66. A protrusion, preferably in the form of a pin 76, also extends from the inlet flange 66, and is positioned generally opposite a midpoint of an arc defined by the three threaded studs 78. The threaded studs 78 and the pin 76 preferably circumscribe a perimeter defining a circle having a first diameter. The retainer plate 68 is retained to the inlet flange 66 by threaded retainers, such as threaded knobs 80 and a nut 82, which, in combination with the threaded studs 78 form connectors. The nut 82 may be any of a variety of standard retainers, for example a hex nut or a wing nut. From this disclosure, the artisan will recognize that others types of connectors, for example clamps, could be substituted for the threaded studs 78 and retainers 80, 82 illustrated. The retainer plate 68 is spaced from the face of the inlet flange 66 to define the slot 70 between the inlet flange 66 and the retainer plate 68. Function of the retainer plate 68, slot 70, threaded studs 78, threaded retainers 80, 82 and pin 76 is described later herein.

A safety interlock switch 72 is preferably provided and mounted on the inlet flange 66. The switch 72 is preferably mounted within the perimeter defined by the threaded studs 78 and pin 76, such that a flat circular plate having an outer diameter equal to the first diameter and positioned within the perimeter circumscribed by the threaded studs 78 and the pin 76 and also positioned adjacent a face of the inlet flange 66 would press against an operative element of the switch 72 to actuate the switch 72. The switch 72 is adapted to prevent operation of the motor 30 and of the fan impeller 92 when the switch 72 is not actuated in a manner well understood by those of ordinary skill in the art.

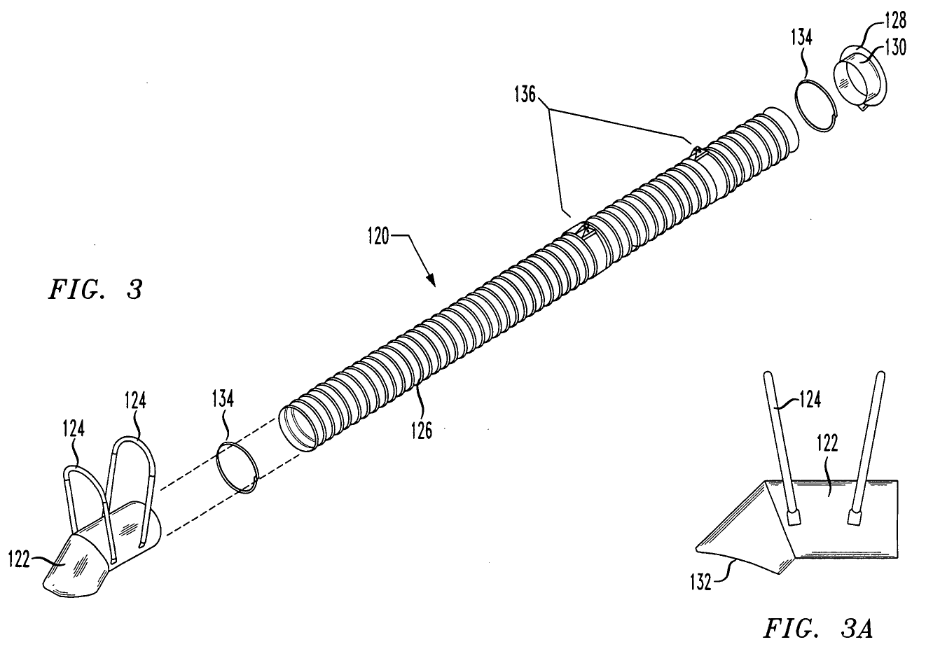

With reference now to FIGS. 3 and 3A, the hose assembly 120 is shown. A hose inlet nozzle 122 is provided at a first end of the hose assembly 120, while a combined hose flange 128 and flange tube 130 are provided at a second end of the hose assembly 120. A hose 126 connects the inlet nozzle 122 and the flange tube 130. The hose 126 is preferably attached to the inlet nozzle 122 and flange tube 130 by band clamps 134. The hose 126 is preferably is of a flexible, corrugated construction. In the preferred embodiment illustrated, the hose 126 has a generally circular cross-section and is of a length preferably on the order of 12 to 15 feet, which would allow it to reach a far corner of a flower or bush bed. The hose 126 may be provided with support rings 136, which allow the hose 126 to be supported by the support arm 22.

The inlet nozzle 122 has an inlet face 132 having a profile which is seen in the side elevational view of FIG. 3A to be non-planar. More particularly, the inlet face has a radiused edge profile. As described below, the non-planar profile prevents the nozzle 122 from attaching to a planar surface (such as flat ground) during use. The nozzle 122 is further seen to preferably include two handles 124, to facilitate manipulation of the nozzle 122 during use.

With particular reference now to FIGS. 3 and 4B, the hose flange 128 preferably has a circular shape, with an outer diameter which is sized to fit snugly within the first diameter circumscribed within the threaded studs 78 and pin 76. The hose flange 128 further has a thickness sized to fit within the slot 70 between the inlet flange 66 and the retainer plate 68. When the hose flange 128 is connected to the inlet flange 66, the hose flange 128 mates with the safety switch 72 to actuate the switch 72.

In general, the components of the fan housing 40 and the discharge chute 110 are fabricated from high strength, high durability metallic materials, such as steel. The hose 126 is preferably conventional industrial vacuum hose, fabricated from flexible, durable, and abrasion-resistant materials, such as polyvinyl chloride (PVC).

In use, the apparatus 10 may be mounted to supporting structure (not illustrated) extending from a rear portion of a truck (not illustrated). A user must first connect the hose assembly 120 to the inlet flange 66 prior to initiating operation. If the hose flange 128 is not secured to the inlet flange 66, the safety switch 72 is not actuated, and the safety switch 72 operates to prevent operation of the motor 30.

The user connects the hose assembly 120 to the inlet flange 66 by first loosening the threaded knobs 80 which are in threaded engagement with the threaded studs 78. Loosening of the threaded knobs 80 serves to enlarge the slot 70 between the retainer plate 68 and the inlet flange 66. With the slot 70 thus enlarged, the user may proceed to install the hose flange 128 within the slot 70, angling the hose flange 128 past the pin 76 into face to face engagement with the face of the inlet flange 66, the outer diameter of the hose flange 128 fitting snugly within the perimeter circumscribed by the threaded studs 78 and the pin 76. The threaded knobs 80 are then tightened to secure the hose flange 128 snugly against the inlet flange 66. In this position, the safety switch 72 is actuated, allowing the motor 30 to operate. Preferably, it is not necessary to loosen the nut 82 positioned opposite the pin 76 to effect the installation process described above.

The threaded knobs 80 need not be fully tightened in order for the apparatus 10 to operate. The safety switch 72 is configured such that even when the slot 70 is sufficiently loose to allow the hose flange 128 to be rotated relative to the inlet flange 66 (but still sufficiently tight to prevent the hose flange 128 from slipping past the pin 76 to become separated from the inlet flange 66), the safety switch 72 continues to be actuated to allow operation of the motor 30. Thus, the user may choose to operate the apparatus 10 with the retainer plate 68 sufficiently loose to allow the hose 126 to be rotated during operation.

Once the hose assembly 120 is secured to the inlet flange 66, operation of the motor 30 and the fan assembly 90 may be initiated by the user. Rotation of the fan impeller 92 creates a vacuum condition at the hose nozzle inlet, creating a flow of air allowing lawn and garden debris (not illustrated), such as leaves, twigs and grass clippings, to be ingested through the hose 126 into the fan housing 50. The debris (not illustrated) first passes through the shredding blades 104 of the blade ring 102. As the debris passes through the shredding blades 104, it receives a first stage of size reduction, being cut into smaller pieces by action of the rotating blade tip edges 108. It is believed that provision of the blade ring 102 (and the additional stage of size reduction) provides an improved level of size reduction of organic debris processed by the apparatus 10 than would be accomplished absent the blade ring 102.

The debris exits the blade ring 102, and continues to move through the fan blades 96, which operate to provide a second stage of size reduction, pulverizing and shredding the debris into even smaller pieces. The debris is carried by the flow of air induced by the fan impeller 92 through the fan housing outlet 58, and is ejected from the discharge chute 110, preferably into a bed of the truck (not illustrated) to which the apparatus 10 is attached.

In view of the non-planar inlet face 132 of the inlet nozzle 122, the propensity that the inlet nozzle 122 would otherwise have to attach itself to flat ground upon which the debris may be resting is eliminated. Thus, effort which would otherwise be wasted by the user in detaching the nozzle 122 from a planar surface to which the nozzle 122 has become attached is also eliminated.

From the foregoing it can be seen that the present invention comprises an apparatus for processing lawn and garden organic debris, having a novel inlet hose connection mechanism allowing the user to quickly and efficiently connect and disconnect an inlet hose to a fan housing. Furthermore, the invention comprises a fan blade design and a blade ring feature which improve performance of the apparatus.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention.

1. An apparatus for processing lawn and garden organic debris comprising:
a fan housing having a wall with an opening for allowing air to pass therethrough;
a retainer plate surrounding a portion of the opening and coupled to the wall, the retainer plate being spaced from the wall to define a slot between the wall and the retainer plate; and
a hose having a nozzle at a first end and a flange at a second end, the flange being releasably positionable in the slot such that the opening and hose are in fluid communication.

2. The apparatus of claim 1 further comprising at least first and second connectors and at least one protrusion extending outwardly from the wall, the connectors and at least one protrusion circumscribing a perimeter, wherein the retainer plate is coupled to the wall by the at least first and second connectors.

3. The apparatus of claim 2 wherein the flange is rotatable with respect to the fan housing while coupled to the wall by the at least first and second connectors.

4. The apparatus of claim 1 wherein the retainer plate has a semi-circular shape.

5. The apparatus of claim 4 wherein the flange has a circular shape.

6. The apparatus of claim 1 wherein the connectors are a combination of threaded studs and threaded retainers.

7. The apparatus of claim 1 wherein the threaded retainers are wing nuts.

8. The apparatus of claim 1 wherein the threaded retainers are threaded hand knobs.

9. The apparatus of claim 1 wherein the protrusion is a pin.

10. The apparatus of claim 1 further comprising a third connector disposed along the perimeter, intermediate the first and second connectors and positioned generally opposite the at least one protrusion.

11. The apparatus of claim 1 further comprising a safety interlock switch disposed on the fan housing wall, the safety switch being actuated when the flange is in the slot to allow the apparatus to be operational.

12. The apparatus of claim 1 further comprising:
a fan assembly mounted for rotation within the fan housing, including a fan impeller having a plurality of fan blades;
each of the plurality of fan blades having a base portion and a tip portion;
the base portions extending generally radially from an axis of rotation of the fan impeller; and
the tip portions being inclined relative to the base portions in a direction opposite a direction of rotation of the fan impeller.

13. The apparatus of claim 12 wherein the tip portion is inclined relative to the base portion at an angle between 50 and 80 degrees.

14. The apparatus of claim 1 further comprising:
a fan assembly mounted for rotation within the fan housing, including a fan impeller having a plurality of fan blades, and
a plurality of shredding blades connected to and projecting forwardly from the fan impeller toward the inlet.

15. The apparatus of claim 14 wherein each of the plurality of shredding blades includes a tip portion having two intersecting angled edges.
